(19) United States
(12) Patent Application Publication
(10) Pub. No.: US 2005/0159188 A1
(43) Pub. Date: Jul. 21, 2005

(54) Management of interaction opportunity data

(76) Inventors: Henning Mass, Aachen (DE); Klaus Weidenhaupt, Aachen (DE); Leonard Poll, Redhill (GB); Paul Rankin, Horley (GB); Steffen Reymann, Redhill (GB); Johannes Jansen, Utrecht (NL); Jiska De Wit, Utrecht (NL)

Correspondence Address: PHILIPS INTELLECTUAL PROPERTY & STANDARDS, P.O. BOX 3001, BRIARCLIFF MANOR, NY, 10510, US

(21) Appl. No.: 10/515,077

(22) PCT Filed: May 15, 2003
(86) PCT No.: PCT/IB03/02068

(30) Foreign Application Priority Data
May 23, 2002 (GB) 0211901.4

(51) Int. Cl. H04B 1/38

(52) U.S. Cl. 455/566; 455/550.1

(57) ABSTRACT

A portable data processing apparatus (120) receives information identifying interaction opportunities for a user of the apparatus and presents them via a display (10). For each identified interaction opportunity, a processor (130) generates a respective display icon (38, 18). The processor generates a user interface having at least first (12), second (16) and third (14) display panes, with newly generated display icons (38) being initially displayed in the first display pane (12). Subsequently, icons (18) are moved to the second display pane (16) and arranged according to a predetermined prioritisation scheme. On user selection of a displayed icon, additional data associated with the selected icon is displayed in the third display pane (14).

The present invention relates to apparatuses having display means operable to display data relating to interaction opportunities for a user of such apparatus. In particular, but not exclusively, the invention relates to apparatus displaying such data in display panels or windows (hereinafter generally referred to as panes) on a single screen or display device, and to methods for managing the presentation and updating of such data displays.

Recent years have seen a great increase in subscribers world-wide to mobile telephone networks and, through advances in technology and the addition of functionalities, cellular telephones have become personal, trusted devices. A result of this is that a mobile information society is developing, with personalised and localised services becoming increasingly more important. Such “Context-Aware” (CA) mobile telephones are used with low power, short range base stations in places like shopping malls to provide location-specific information. This information might include local maps, information on nearby shops and restaurants and so on. With other personal and portable devices, such as personal digital assistants (PDA's) and laptop computers, gaining the technical features also to support such interaction, the number of CA terminals is also beginning to increase.

An example of a CA terminal is given in U.S. Pat. No. 5,835,861 which discloses the use of wireless telephones within the context of advertisement billboards. The user of a wireless telephone obtains the telephone number of a vendor by activating his/her wireless telephone to transmit a prompt signal to an active advertisement source and to receive from the advertisement source a response signal containing the telephone number of the advertising vendor. The telephone number can then be used to automatically place a call to that vendor via the public switched telephone network. Alternatively, the telephone number can be stored for use later on. This arrangement can be used to place a call to a vendor without having to either memorise the telephone number or to write it down. The signals between the billboard and the caller can be transmitted as modulated infrared (IR) signals.

A problem that users are increasingly faced with is the volume of data relating to interaction opportunities that is available. The user's CA terminal may be equipped to filter the information received according to pre-stored user preferences, and the user only alerted if an item of data of particular interest has been received, but there is still a need to effectively manage the information that does pass the filter.

It is accordingly an object of the present invention to provide a means for presentation of interaction information to a user which gives improved utilisation of display capacity per unit area of display surface.

It is a further, subsidiary, object to provide such a system supporting improved indexing and access facilities for the user.

In accordance with a first aspect of the present invention there is provided a portable data processing apparatus being operable to receive information identifying interaction opportunities for a user of the apparatus and present the same to said user via a display, the apparatus comprising:
a processor coupled with data storage means and said display and programmed to generate a respective display icon for each identified interaction opportunity; and
user operable input means for selecting a displayed icon;
wherein the processor is arranged to generate a user interface having at least first, second and third display panes, with newly generated display icons being initially displayed in said first display pane and subsequently moved to said second display pane wherein other icons are displayed; wherein the processor is configured to arrange the icons in the second display pane according to a predetermined prioritisation scheme; and wherein on user selection of a displayed icon additional data associated with the selected icon is displayed in the third display pane. By the provision of the particular arrangement of panes, the user can quickly identify newly-arrived interaction opportunities (first pane), more easily find those likely to be of interest (prioritised arrangement in the second pane), and call up further information (third pane) without obscuring the first two panes.

The apparatus may be arranged to determine from the information identifying interaction opportunities a respective priority for each, with the predetermined prioritisation scheme applied by the processor positioning those display icons in the second display pane in order of priority relative to the position of the first display pane. The predetermined prioritisation scheme applied by the processor may comprise complex schemes for evaluating and prioritising opportunities, or it may be as simple as temporal prioritisation with those display icons in the second display pane being displayed in the order they arrived in the first display pane.

For improved clarity, the processor may be configured to identify, from the received information, a plurality of different classes of interaction opportunity and to indicate the same to a user by the form of display icon presented for each identified interaction opportunity. Such different forms of icon may be determined at least partly by data held in the data storage means, and/or they may be delivered from a remote source with the interaction opportunity data.

The processor may be operable to receive additional information relating to an interaction opportunity for which an icon is already displayed in the second display pane: in such a case, the processor may indicate the arrival of said information to the user by altering the appearance of the respective display icon in the second display pane, rather than congesting the second pane by the addition of a further icon.

The apparatus may comprise means coupled with the processor and operable to receive said information identifying interaction opportunities from at least one remote source, preferably (though not essentially) by wireless download. To further facilitate interaction with remote sources, the processor may be further operable to generate in said third display pane a visual representation of the location of said at least one remote source relative to the location of the apparatus and/or a representation of relative valuations for two or more remote sources to the apparatus.

In combination with the appearance of an icon in the first display pane, the apparatus may further comprise means controlled by the processor to generate an alert to a user on the generation of a new icon in the first display pane (i.e. on the detection of a new interaction opportunity). Such means may suitably include sounders or vibration devices such that the user can be alerted even if not looking at the user interface at the time, as may be necessary when walking in a crowded environment, for example.

To identify to the user how recently a new opportunity has arisen, the processor may be arranged to scroll an icon in the first display pane from one edge of the pane to an opposite edge prior to moving such icon to the second display pane. With multiple opportunities being received close together, the first pane acts as a pipeline along which the icons pass before being arranged in prioritised order in the second pane.

The apparatus may be further operable to facilitate user alteration of device settings through the same arrangement of user interface, with options for setting nested in menus with submenus for respective entries, with respective icons in the first display pane representing menu items on selection of one of which icons are presented in the second display pane representing the respective submenu options, and on selection on one of the icons in the second display pane, the individual device setting options under that submenu are shown in the third display pane.

Also in accordance with the present invention there is provided a method for managing the presentation of information identifying interaction opportunities to a user via a user interface, comprising the steps:
generating a user interface having at least first, second and third display panes;
generating a respective display icon for each identified interaction opportunity and initially displaying the same in said first display pane;
subsequently moving the icon from the first to the second display pane wherein other icons are displayed;
arranging the icons in the second display pane according to a predetermined prioritisation scheme; and
on user selection of a displayed icon, displaying additional data associated with the selected icon in the third display pane. The invention further provides a computer readable storage medium containing executable instructions for performing the above method steps.

Further features and advantages of the present invention will become apparent from reading of the following description of preferred embodiments of the present invention, given by way of example only, and with reference to the accompanying drawings, in which:

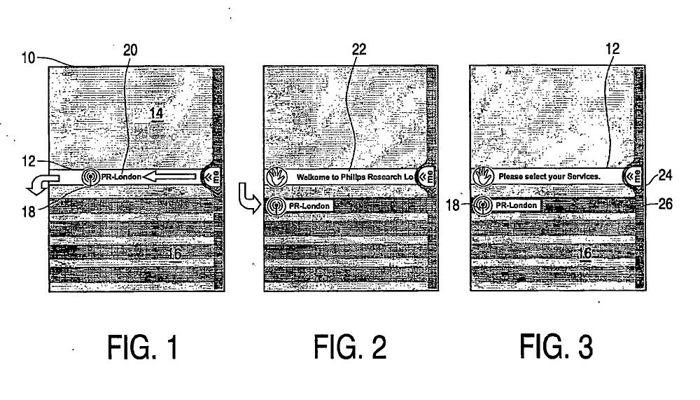

FIGS. 1 to 30 are images of a user interface presenting information identifying interaction opportunities; and

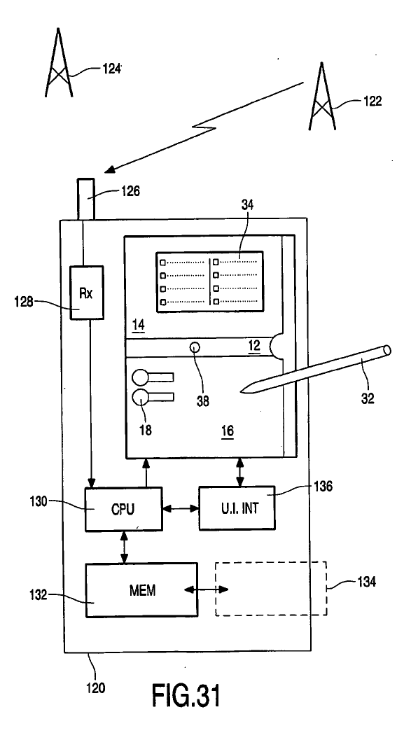

FIG. 31 schematically represents a device embodying the invention in conjunction with external sources of interaction opportunities.

In the following, interaction mechanisms are described to support a mobile device user's management of the activation of applications on the move. These mechanisms are illustrated in FIGS. 1 to 30 which show a user-interface design in which:

The mechanisms allow easy management of both user-initiated applications (‘pull’) as well as applications initiated automatically or externally (‘push’) by a new situation, device, network, time, place or social-context event.

Both the management of opportunities for peer-to-peer and for client-server applications are unified under an easy-to-use user interface.

The design has two modes—one for supporting the user on the move (Opportunity Management Mode), one for the user to configure a number of sets of personal preferences, filters and priorities for different application opportunities they may encounter in different contexts (Personal Settings Mode).

Although the design is illustrated by the screen design of a PDA, other handset formats and devices, such as a mobile phone or a laptop, can implement the mechanisms.

Opportunity Management Mode

A simple example of an opportunity for interaction might be an incoming phone call or SMS message signalled by a ringing tone and the caller's ID. Alternatively, an opportunity might be for the user's wireless headset to receive audio privately when within range of TV, or a nearby computer projection system to which the user could beam a presentation or a printer, or the proximity of a large public display which the user can appropriate temporarily. Such events might also include a reminder alert to make a phone call, triggered by the user's calendar system. Another example might be the event of a user entering the coverage of a short-range RF beacon that offers local services or the pointers to wide-area network services. Yet another example might be coming within range of an IR signal transmitted from another user's handset offering wireless exchange of business cards.

Considering initially the sequence of FIGS. 1 to 18, the user interface screen 10 is divided by a central pane 12 into an upper part 14 for viewing and interacting with an application, and lower part 16 for monitoring the current set and state of opportunities. The pane 12 acts as a ‘pipeline’ for the announcing the arrival of new opportunities/events that pass the user's current personal filter. These are signalled by icons 18 arriving on the pane from the right hand side: the particular form of icon 18 represents the class of opportunity. The new event may also be signalled to a user by a special vibration pattern or accompanied by a signature sound indicating the event's category or class, for example.

These icons 18 trail an explanatory title 20 and possibly also further messages (22; FIG. 2) which scroll from right to left as with a ticker-tape. The event shown in FIGS. 1 to 8 is an opportunity to interact with location-based services, as a result of a beacon signal that has been discovered or ‘pushed’ to the user's handset from an RF or IR beacon which the user has just encountered.

The new opportunity for user interaction then moves down onto a ‘rack’ of opportunities maintained in a push-down stack in pane 16 (FIGS. 2 and 3). This stack may be ordered in different ways. The latest opportunities may be simply put at the top, so then the whole stack of events of the day or week can be reviewed by scrolling down through a long rack. Alternatively, the higher the priority that a new event or opportunity has for the user in their current context (priorities set for example by their current set of personal preferences), the higher on the stack (i.e. closest to the first pane 12) that the event-icon 18 comes to rest. New high-priority events may therefore push down older events, whilst new low priority events will find their place lower in the stack. Thus the user can focus on highest priority events on bars (horizontal lines in the rack) closest to the centre of the screen. The rack can be scrolled up or down, for example via the hotspot or control icon 24 at the right of the screen.

Each new opportunity, such as encountering a short-range RF beacon may offer a number of different applications. For example a beacon may offer (pointers to) services for navigation assistance, commercial offers or stored messages left in that place for the user to read. In this case, the horizontal bar 26 on the rack in the pane 16 will show:

On the left an event-icon 18 identifying the source of the opportunity and its category (e.g. a RF beacon for location-based services). This icon allows the user to quickly assess some characteristics of the application source, such as the trustworthiness of services on offer, or how well the user personally knows the sender of messages.

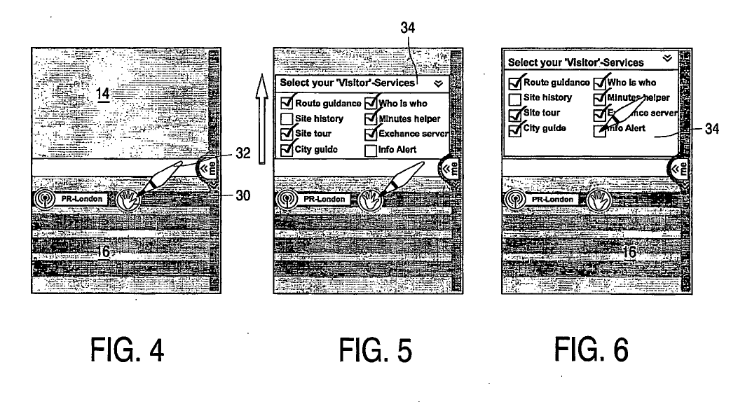

To the right a number of icons (30; FIG. 4), one per possible application, again optionally with graphics/accompanying sounds indicating the category of service offered, and optionally also tagged by whether these are visible in the top pane (application space) 14, or are waiting for user interaction (e.g. by the hand icon 30 as in FIG. 4), or are now passive, or are non-interactive (e.g. one-way broadcast information).

FIG. 4 shows the activation (using PDA pointer 32) of an application to provide a visitor's guide after encountering a RF beacon. The amount of handset screen space in the top pane 14 devoted to running and interacting with a specific application is manually or automatically adjustable, so more screen area can be devoted to the application, or to the rack in the lower pane 16 monitoring different application opportunities: for example, the pipeline pane 12 might be dragged lower on the screen via a hotspot.

In an alternative arrangement, where the host device comprises (or has means for connection to) two display devices, the two screens might be synchronised, one for the opportunity monitor, one for the application interaction.

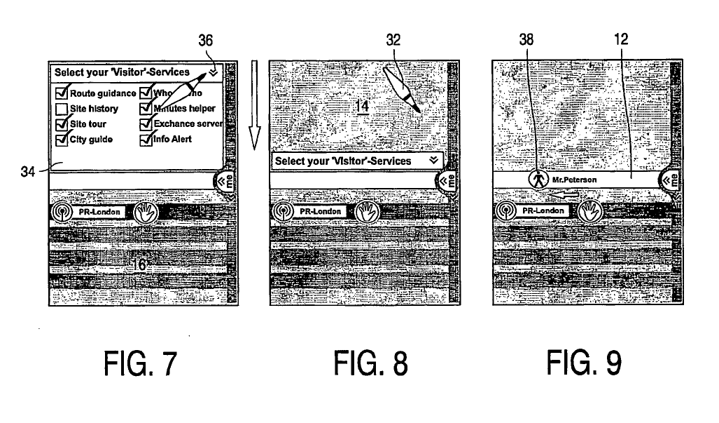

On activating an application, then the application-interaction area 34 in top pane 14 scrolls upward from the centre pane 12 as in FIG. 5 and interaction proceeds, for example with the user checking option boxes as in FIG. 6. The application is then closed by selecting a ‘minimise’ hotspot 36 in the upper right hand corner of the application interaction area 34, as in FIG. 7. The application interaction area 34 then slides down to the centre pane and disappears, as in FIG. 8.

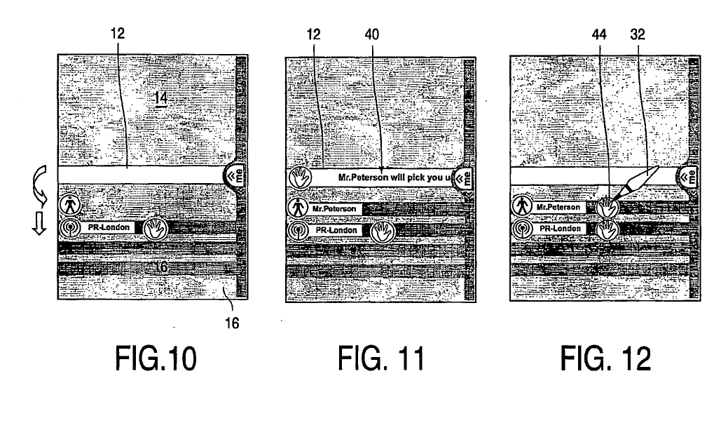

FIG. 9 shows the advent of a new opportunity-source, the handset's RF unit having detected the nearby presence of a person, Mr. McPeterson. This event-icon 38 moves from right to left across the centre pane 12 and then down to form a second bar on the rack of currently-active opportunities for user interaction in the lower pane 16 (FIGS. 10 and 11). As with the example in FIG. 2, the icon 38 trails a further message 40 which scrolls across the centre pane 12.

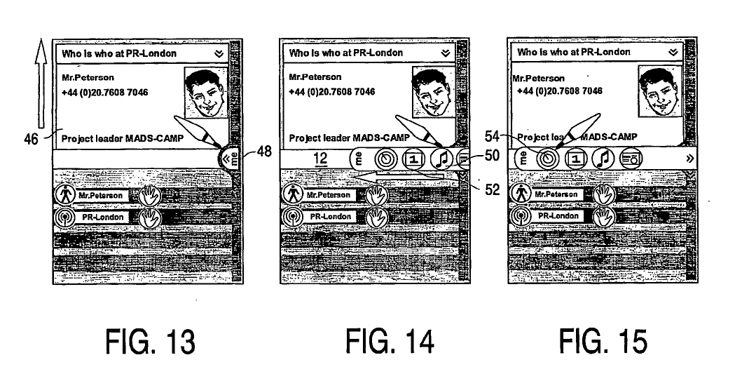

In FIG. 12, the user activates one application that the source, Mr. McPeterson has on offer for interaction, and by pointer 32 selection of a hand icon 44. On activation, this application delivers a business card 46 for Mr McPeterson as seen in FIG. 13.

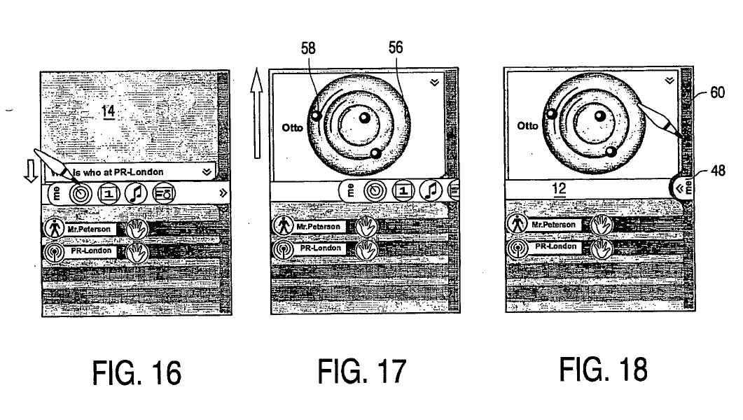

So far in this description, the events have been triggered externally and opportunities for interaction have appeared spontaneously (pushed) to the user. The next sequence covering FIGS. 13 to 18 illustrates the user manually activating an application (pull). By touching the icon 48 on the right hand of the centre pane 12 shown as ‘me’ in FIG. 13, a set of pre-selected applications, or ‘tools’ that the user can activate in their currently active context emerge from right to left across the centre pane 12, as shown in FIG. 14. These tools may be for example a music player 50 or a calendar 52 as depicted by the icons on the first pane 12 in FIG. 14. In FIG. 15, a ‘radar function’ icon is selected. This application searches and alerts the user of the proximity of nearby people who are projecting an RF ‘aura’ that the handset can detect, or who have their locations tracked by an external infrastructure or service provider, at the same time clearing the previous item (business card 46) from the upper pane 14, as shown in FIG. 16.

The radar function visualises 56 how important or interesting nearby people are depending on the user's current context. Each nearby person is visualised with an icon inside the radar associated with a descriptive name (e.g. Otto in FIG. 17). The more interesting or relevant that other people are, then the closer to the radar's centre they are drawn. Thereby the user can easily assess a large number of nearby people for interaction opportunities. The radar may also be extended to show the relevance of nearby devices, services, and places in addition to people. As an alternative (or additional functionality) where positioning location is available for the remote sources, the relative positions on the radar of the radar icons may indicate their relative geographical positions to the user.

In FIG. 18, the user then switches (by pointer selection of the vertical bar 60 at the edge of the upper pane 14) modes to view and adjust their personal settings and possibly also to change their currently selected context and its filtering of incoming opportunity-events, as will be discussed in greater detail below.

The user suitably has a number of such opportunity-filters that both screen out and prioritise ‘pushed’ events and/or the applications they carry. For instance, these filters may be for running in the user's contexts of:
At home
At work
Doing sports
Leisure Time
On the Move

The icon ‘me’ 48 on the right hand of the first pane 12 in FIG. 18 indicates that the ‘On the Way’ context (and its associated filtering and prioritisation) is currently active. In contrast, FIG. 29 shows a ‘house’ icon on the right of the pipeline, indicating that the ‘At Home’ settings are currently active. Note that the current filter and settings may be influencing (invisible) programs or remote applications with which the user does not directly or explicitly interact on the handset. For example, the ‘At Work’ context selection may influence the settings of their home heating, answering machine or security systems. Also note that the selection of which of the ‘contexts’ is active may be done explicitly by the user. Alternatively, however the user may decide to is delegate the context switching (and so the selection of active filters, priorities and application tools) to an externally detected event. This context-controlling event or situation may be the entry to a sports hall, shopping mall or work office (sensed by RF/IR beacons, RF-ID tags or GPS location)- or to the time of day, or indeed to the proximity of other people of a certain group. In principle any automatically-detected change of state might be the trigger for an automatic context change.

Personal Settings Mode

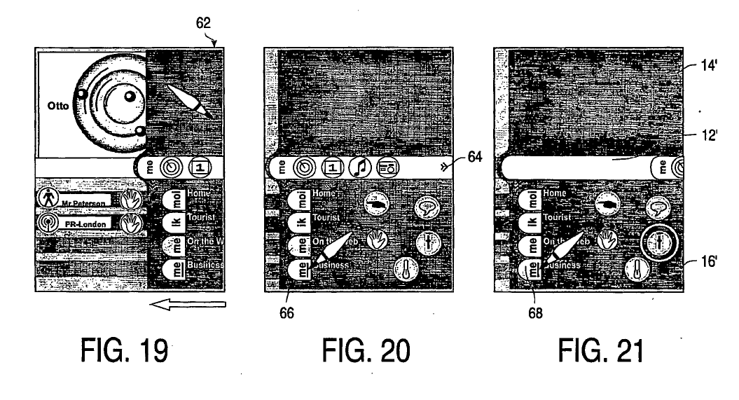

In FIG. 18, the user has activated a change of modes by clicking on the right-hand bar 60. The personal-settings screen view 62 then scrolls out over the opportunity-event and application view as in FIG. 19. The mode can be reversed again by selecting the arrows icon 64 on the right hand end of the pipeline in FIG. 20, as is shown being done in FIG. 26.

In the personal settings mode, the screen is again split into upper and lower panes 14′, 16′, divided by a horizontal central pane 12′, acting as the visual focus for the user. The lower part, 16′ is for the main selections between different user contexts (‘Home’, ‘Tourist’, ‘Business’ etc) and the assignments of their associated sets of applications. The upper part, 14′ Is for the detailed set-up of application preferences.

In FIG. 20, four tools can be seen as currently available in the ‘On the Way’ context by the presence of icons on 12′, representing the radar, calendar, music and information board applications. These are available in the context of ‘On the Way’ (the third-from-top icon 66 in the column on the right-hand side of 16′ shown shaded to indicate that it is active).

In FIG. 21, a change is made to the ‘Business’ context (the lowest icon 68 in the column on the right hand side of 16′). The old application-tool set slides away as shown and a new set appears from right to left on the pipeline. As with all other operations with the user-interface, feedback on such actions may optionally be reinforced by sounds, tunes or vibration patterns which can also be a channel to inform the user of other properties of the handset, situation, peer, opportunity source context or application.

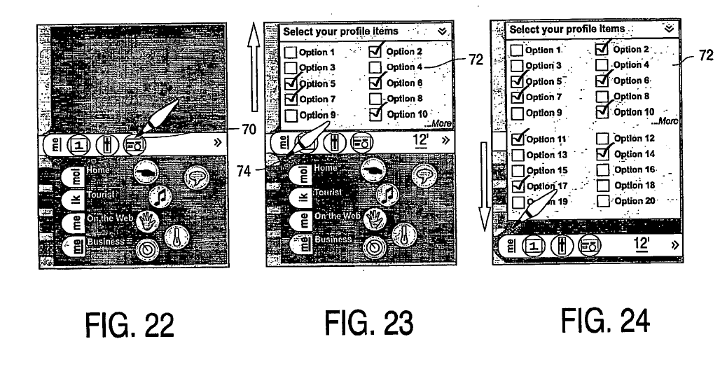

In FIG. 22 one of the ‘Business context’ tools 70 is selected for personal adjustment. The profile-settings view 72 for this information tool emerges scrolling upwards from the central pane 12′ as in FIG. 23. As with the other mode, the user can devote more screen space to view this application's settings via the scroll hotspot at 74, moving the central pane 12′ down and leading to the view in FIG. 24.

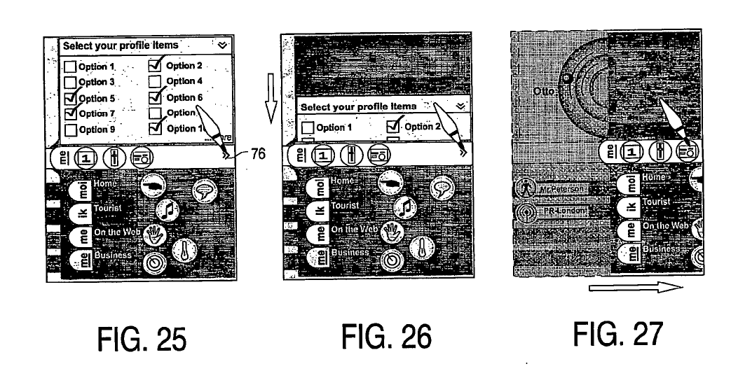

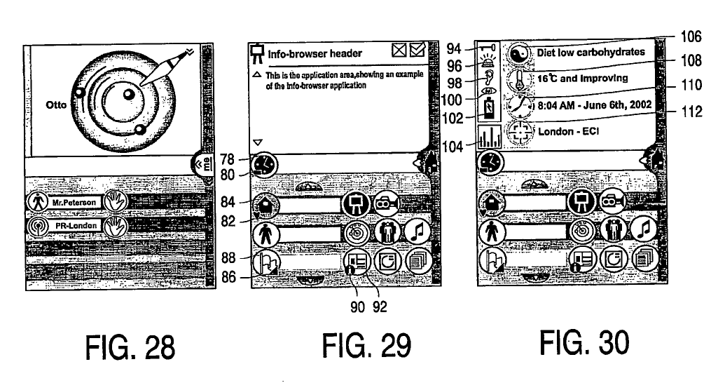

After the user has completed in this mode any personal preference and setting adjustments, plus their prioritisation of tool/applications/alerts for different contexts (see FIG. 25), then the user's activates the arrow hotspot 72 on the right hand end of the central pane 12′. This closes the settings view 72 (as in FIG. 26) and then slides the second mode's screens away (FIG. 27), returning to the opportunity-event manager of the first mode, with the radar application currently activated, as in FIG. 28.

Returning to the Opportunity Management mode, a number of more sophisticated extensions are possible, as shown in FIGS. 29 and 30. As examples, the clock icon at 78 has a bubble 80 indicating that explanatory text is available. The heart 82 added to the event-icon 84 on the left of the bar indicates that this carries a trusted set of applications which are very personal for the user. A heart added to an event-icon associated with a service indicates the user is a known subscriber to that service. A heart added to an event-icon representing a person indicates that this source is a trustworthy or known person (e.g. from earlier interactions or being a colleague or friend).

The downward pointing triangle 86 on the event-icon at 88 shows that this is from a cluster of applications that can be expanded further. (Note especially that one event may open up an hierarchy of groups of application opportunities of different types for the user.) The ‘i’ annotation 90 on icon 92 indicates that this application is waiting for interaction from the user.

In FIG. 30 the states of a number of monitors running on the handset (or interrogated by the handset) are shown in the upper pane 14 when no other applications are using that screen area. For instance, in the left-most column, running top to bottom, icons indicate:
at 94 that the house is currently locked;
at 96 that an alert has fired about the price of the user's stock;
at 98 that handset sounds are activated (ear icon);
at 100 that the screen is also turned on (eye icon);
at 102 that the battery is getting low; and
at 104 that there is a strong GSM network signal.

The second column of monitors suggests nutritional advice for the day (106), the current temperature (108), the current time (110), and at 112 the user's current location (determined by mobile cell ID, GPS, RF beacon or another manner).

As mentioned above, the host apparatus of the interface may comprise a PDA, mobile telephone, laptop or like device. FIG. 31 shows the principal components of such a device 120 embodying the invention and with interaction opportunities from two remote sources, beacons 122, 124. Information about the interaction opportunities from beacon 122 is picked up by antenna 126 (which may be external or internal to the device 120) and, via a receiver and decoder stage 128, the received data is passed to a central processor 130.

Coupled with the processor 130 is a data storage means 132, which may comprise both read-only and random access memory suitably linked to the processor by addressing and data buses. As indicated by the dashed line at 134, the memory 132 may be supplemented by removable storage means, such as floppy or optical disc, memory sticks, solid state memory cards and the like. The data storage includes the program instruction for controlling the processor to generate and manage the user interface as described hereinabove with reference to FIGS. 1 to 30.

Also coupled to the processor 130 is a display device 10 on which the user interface is presented. User input means are also coupled to the processor to support the user interaction with the detected interaction opportunities and also with the interface itself (for example in the Personal Settings mode). The form of user input device will be to some extent dictated by the form and function of the device 120 as a whole. For example, where the device is a laptop computer, the user input device will typically comprise a full alpha-numeric keyboard as well as an x/y cursor control (either integral or through a plugged in mouse or trackball device). Where the device is a mobile telephone, the number of keys for inputting data is likely to be greatly reduced, and mechanisms such as a touch sensitive screen coupled with option menu generation may be used. In the example shown, the device is a PDA (or similar) with a touch screen interface 136 coupled with the display device (typically a liquid crystal device) 10, with user selection of items displayed on the user interface being effected by use of a pointer device 32.

From reading the present disclosure, other variations will be apparent to persons skilled in the art. Such variations may involve other features which are already known in the field of apparatuses having graphical or screen display interfaces or component parts thereof and/or methods for control of the same and which may be used instead of or in addition to features already described herein.

1. A portable data processing apparatus being operable to receive information identifying interaction opportunities for a user of the apparatus and present the same to said user via a display, the apparatus comprising:
a processor coupled with data storage means and said display and programmed to generate a respective display icon for each identified interaction opportunity; and
user operable input means for selecting a displayed icon;
wherein the processor is arranged to generate a user interface having at least first, second and third display panes, with newly generated display icons being initially displayed in said first display pane and subsequently moved to said second display pane wherein other icons are displayed; wherein the processor is configured to arrange the icons in the second display pane according to a predetermined prioritisation scheme; and wherein on user selection of a displayed icon additional data associated with the selected icon is displayed in the third display pane.

2. Apparatus as claimed in claim 1, being arranged to determine from said information identifying interaction opportunities a respective priority for each, wherein said predetermined prioritisation scheme applied by the processor positions those display icons in the second display pane in order of priority relative to the position of the first display pane.

3. Apparatus as claimed in claim 1, wherein said predetermined prioritisation scheme applied by the processor positions those display icons in the second display pane in the order they arrived in the first display pane.

4. Apparatus as claimed in any of claims 1 to 3, wherein the processor is configured to identify, from said received information, a plurality of different classes of interaction opportunity and to indicate the same to a user by the form of display icon presented for each identified interaction opportunity.

5. Apparatus as claimed in claim 4, wherein the form of each display icon is determined at least partly by data held in said data storage means.

6. Apparatus as claimed in any of claims 1 to 5, wherein the processor is operable to receive additional information relating to an interaction opportunity for which an icon is already displayed in the second display pane and to indicate the arrival of said information to the user by altering the appearance of the respective display icon in the second display pane.

7. Apparatus as claimed in any of claims 1 to 6, comprising means coupled with said processor and operable to receive said information identifying interaction opportunities from at least one remote source.

8. Apparatus as claimed in claim 7, wherein the processor is further operable to generate in said third display pane a visual representation of relative valuations for two or more remote sources to the apparatus.

9. Apparatus as claimed in claim 7 or claim 8, wherein said means operable to receive said information is a wireless receiver.

10. Apparatus as claimed in any of claims 1 to 9, further comprising means controlled by the processor to generate an alert to a user on the generation of a new icon in the first display pane.

11. Apparatus as claimed in any preceding claim, wherein the processor is arranged to scroll an icon in the first display pane from one edge of the pane to an opposite edge prior to moving such icon to the second display pane.

12. Apparatus as claimed in any preceding claim, wherein the first display pane is positioned between the second and third display panes on the apparatus display.

13. Apparatus as claimed in any preceding claim, being further operable to facilitate user alteration of device settings through said user interface, wherein options for setting are nested in menus with submenus for respective entries, with respective icons in the first display pane representing menu items on selection of one of which icons are presented in the second display pane representing the respective submenu options, and on selection on one of the icons in the second display pane, the individual device setting options under that submenu are shown in the third display pane.

14. A method for managing the presentation of information identifying interaction opportunities to a user via a user interface, comprising the steps:
generating a user interface having at least first, second and third display panes;
generating a respective display icon for each identified interaction opportunity and initially displaying the same in said first display pane;
subsequently moving the icon from the first to the second display pane wherein other icons are displayed;
arranging the icons in the second display pane according to a predetermined prioritisation scheme; and
on user selection of a displayed icon, displaying additional data associated with the selected icon in the third display pane.

15. A computer readable storage medium containing executable instructions for performing the method steps of claim 14.
